(19) United States
(12) Patent Application Publication
(10) Pub. No.: US 2026/0109615 A1
(43) Pub. Date: Apr. 23, 2026

(54) A RECYCLING METHOD FOR RECOVERY OF VALUABLE METAL ELEMENTS FROM WASTE BATTERY MATERIALS

(71) Applicant: GELION TECHNOLOGIES PTY LTD, New South Wales (AU)

(72) Inventors: Koen VANDAELE, Sonning, Common (GB); Andreas TSOLIGKAS, London (GB); Barbara BREEZE, Sonning, Common (GB)

(73) Assignee: GELION TECHNOLOGIES PTY LTD, New South Wales (AU)

(21) Appl. No.: 19/111,488

(22) PCT Filed: Sep. 14, 2023
(86) PCT No.: PCT/AU2023/050883

§ 371 Date: Mar. 13, 2025

(30) Foreign Application Priority Data
Sep. 14, 2022 (GB) 2213410.0

(51) Int. Cl. C01D 15/02; C01D 15/04; C01D 15/08; C22B 1/02; C22B 3/00; C22B 7/00; C22B 47/00; H01M 10/54

(52) U.S. Cl. CPC C01D 15/02; C01D 15/04; C01D 15/08; C22B 1/02; C22B 7/007; C22B 23/043; C22B 47/00; H01M 10/54

(57) ABSTRACT

A method of recycling a waste battery cathode material comprising lithium and at least one of nickel, cobalt and/or manganese, the method comprising: heating the waste battery cathode material in a reducing atmosphere to form a heat-treated waste battery cathode material comprising LiF and one or more of LijO, LiOH, and LijCOs; washing the heat-treated waste battery cathode material in an aqueous solvent to extract both lithium containing species and fluorine containing species, wherein the aqueous solvent does not contain an alkaline earth hydroxide or other species intended to reduce or prevent soluble fluorine species remaining dissolved in the aqueous solvent; separating the aqueous solvent comprising lithium and fluorine species from the heat-treated waste battery material; after separating the aqueous solvent comprising lithium and fluorine species from the heat-treated waste battery material, treating the aqueous solvent to separate lithium species from fluorine species; recovering the lithium species as lithium hydroxide or lithium carbonate; forming an acidic aqueous recycling feed comprising one or more of nickel, cobalt and/or manganese by leaching the heat-treated waste battery cathode material with an inorganic acid after the step of separating the aqueous solvent from the heat-treated waste battery material; and recovering one or more of nickel, cobalt and/or manganese from the acidic aqueous recycling feed via one or more further process steps selected from solvent extraction, solid phase extraction, electrochemical extraction, and precipitation processes.

### RELATED APPLICATION

This application claims priority from Great Britain Patent Application No. GB2213410.0 filed on 14 Sep. 2022, the entire contents of which are incorporated herein by reference.

### FIELD

The present invention relates to a recycling method for recovery of valuable metal elements from waste battery materials. The method is applicable to waste battery cathode materials which comprise lithium, fluorine species, and one or more of nickel, cobalt and/or manganese. However, it will be appreciated that the invention is not limited to this particular field of use.

### BACKGROUND

Lithium-ion batteries are now ubiquitous in modern society, finding use not only in small, portable devices such as mobile phones and laptop computers but also increasingly in electric vehicles. A lithium-ion battery generally includes a graphite anode separated from a cathode by an electrolyte, through which lithium ions flow during charging and discharging cycles. The cathode in a lithium-ion battery may include a lithium transition metal oxide, for example a lithium nickel oxide, lithium cobalt oxide or lithium manganese oxide.

Although lithium-ion and other modern rechargeable batteries offer a promising low-carbon energy source for the future, one concern is that the metals required for their manufacture, such as lithium, nickel, cobalt and/or manganese, often command high prices due to their limited availability and difficulty of extraction from natural sources. There is therefore a need for methods which recycle or purify the metals present within batteries, such as the metals present within the cathodes of batteries, to provide materials which may be used as feedstock in battery manufacture.

During battery material recycling processes, an effluent solution is generated containing valuable metal elements such as cobalt and nickel which could be used in the manufacture of new battery materials if they could be extracted in sufficient purity. Such solutions may be generated by leaching from waste battery materials including so-called “black mass”, a mixture of valuable metals alongside unwanted impurities. The leaching may be performed using an inorganic acid, such as sulfuric acid, to generate an acidic aqueous recycling feed comprising a mixture of valuable metal species. One or more valuable metal elements can then be recovered from the acidic aqueous recycling feed via one or more further process steps selected from solvent extraction, solid phase extraction, electrochemical extraction, and precipitation processes.

In one approach for battery cathode materials comprising Li, Mn, Co and Ni, all of these elements are dissolved in inorganic acid and then selectively separated from the aqueous acidic feed. However, it can be difficult to extract the Mn, Co, and Ni without Li contamination and conversely it can be difficult to extract the Li without sodium ion contamination introduced during the treatment of the acidic feed. As such, it has been proposed that for waste battery materials comprising lithium and one or more of nickel, cobalt and/or manganese, it can be advantageous to extract the lithium from the waste battery material prior to forming the acidic aqueous recycling feed comprising one or more of nickel, cobalt and/or manganese. For example, WO2022/079409 discloses selectively leaching lithium from wase battery material using an organic acid, such as formic acid, prior to forming an acidic aqueous recycling feed comprising one or more of nickel, cobalt and/or manganese via an inorganic acid dissolve.

Another example for recovering lithium from waste battery material is disclosed in WO2020011765. This prior art document discloses a process which comprises: heating a lithium containing transition metal oxide material to a temperature in the range of from 200 to 900° C. in the presence of H₂; leaching lithium species from the heat treated material with water or a weak acid; and recovering the lithium as hydroxide or carbonate from the leachate by precipitation.

Yet another example of recovering lithium from waste battery material is disclosed in WO2021018778. This prior art document discloses a similar process to that described in WO2020011765 but uses an aqueous solution of an alkaline earth hydroxide (e.g., calcium hydroxide) to leach lithium species from heat treated waste battery material. That is, the process comprises: heating a lithium containing transition metal oxide material in the presence of H₂; leaching lithium species from the heat-treated material using an aqueous solution of an alkaline earth hydroxide; separating the leachate from the remaining solid residue; and recovering the lithium as hydroxide or carbonate from the leachate by precipitation. The alkaline earth hydroxide reacts with soluble fluorine containing species to precipitate as alkaline earth fluoride. As such, the fluorine remains in the solid waste battery material residue rather than dissolving into the leachate with the lithium species. This has the advantages that the lithium containing leachate has much less fluorine contamination and the purity of lithium hydroxide or lithium carbonate precipitated from the leachate can be improved (e.g., when compared to the process described in WO2020011765).

It is an aim of the present specification to at least partially address this problem, or at least provide a useful alternative.

It is an object of the present invention to overcome or ameliorate one or more of the disadvantages of the prior art, or at least provide a useful alternative.

### SUMMARY OF INVENTION

The approach described in WO2021018778 is focused on improving the purity of the lithium containing leachate by ensure that fluorine in soluble fluorine containing species such as LiF remains in the solid residue of the waste battery material. In this regard, an alkaline earth hydroxide is used to ensure that any fluoride which dissolves in the aqueous leach liquid is precipitated back into the solid residue as an alkaline earth fluoride, such that Li is primarily leached out as LiOH. While this approach can improve the purity of the lithium containing leachate, the approach is problematic if the remaining solid residue of the waste battery material is subsequently subjected to an inorganic acid leach to form an acidic aqueous recycling feed comprising one or more of nickel, cobalt and/or manganese. This is because the alkaline earth fluoride remaining in the solid residue of the waste battery material can result in HF being formed in the acidic aqueous recycling feed. For example, while calcium fluoride is insoluble in water, hence not passing into the lithium leachate during the aqueous lithium leaching step, it reacts with sulfuric acid to yield calcium sulphate and hydrogen fluoride (HF). Considering the serious environmental health and safety risks and material compatibility implications related to HF, it is desirable to remove fluorine containing species present in waste battery material which would result in HF generation if the material is to be subjected to an inorganic acid dissolve.

Accordingly, the present specification provides a method of recycling a waste battery cathode material comprising lithium and at least one of nickel, cobalt and/or manganese, the method comprising:
heating the waste battery cathode material in a reducing atmosphere to form a heat-treated waste battery cathode material comprising LiF and one or more of Li₂O, LiOH, and Li₂CO3;
washing the heat-treated waste battery cathode material in an aqueous solvent (e.g., water) to extract both lithium containing species and fluorine containing species, wherein the aqueous solvent does not contain an alkaline earth hydroxide or other species intended to prevent fluorine remaining dissolved in the aqueous solvent;
separating the aqueous solvent comprising lithium and fluorine species from the heat-treated waste battery material;
after separating the aqueous solvent comprising lithium and fluorine species from the heat-treated waste battery material, treating the aqueous solvent to separate lithium species from fluorine species;
recovering the lithium species as lithium hydroxide or lithium carbonate;
forming an acidic aqueous recycling feed comprising one or more of nickel, cobalt and/or manganese by leaching the heat-treated waste battery cathode material with an inorganic acid after the step of separating the aqueous solvent from the heat-treated waste battery material; and
recovering one or more of nickel, cobalt and/or manganese from the acidic aqueous recycling feed via one or more further process steps selected from solvent extraction, solid phase extraction, electrochemical extraction, and precipitation processes.

As such, the present method is targeted at extracting lithium species (e.g., as LiOH and/or Li₂CO₃) and also soluble fluorine species (e.g., as LiF) from the waste battery cathode material prior to subjecting the waste battery cathode material to an inorganic acid leach. Only after separating the Li/F containing leachate from the heat-treated waste battery cathode material is a treatment step provided for the leachate to separate the Li and F. The step of treating the aqueous solvent to separate lithium species from fluorine species may comprise addition of an alkaline earth hydroxide such that fluorine species are precipitated as an alkaline earth fluoride which is then separated from the aqueous solvent by a solid-liquid separation process. However, the difference here is that the alkaline earth hydroxide is only added to the aqueous solvent after it has been separated from the heat-treated waste battery material. This has the advantage of achieving high purity LiOH (or Li₂CO₃) while also ensuring that HF forming species (e.g., alkaline earth fluorides) are not left in the solid waste battery material during a subsequent inorganic acid leaching step. The lithium can then be recovered from the aqueous solvent either by precipitating as LiOH or recovered as Li₂CO₃ by adding CO₂ in a similar manner to that described in WO2021018778.

As an alternative to precipitating the fluorine using an alkaline earth hydroxide, it is also possible to use other reactants to precipitate out fluoride material and thus separate fluorine and lithium species using a solid-liquid separation process. Examples of fluoride precipitation reactants include alkali and alkaline earth metal chlorides, hydroxides, carbonates, bicarbonates, acetates, formates, and mixtures of two or more of these reactants. For example, the combination of CaCl₂ and Ca(OH)₂ or NaOH and CaCl₂ can be used in the fluoride precipitation process. Other examples include calcium chloride, calcium bicarbonate, calcium acetate and calcium formate. In this regard, it has also been noted that calcium hydroxide has a relatively poor solubility and is therefore not optimal for precipitating out large amounts of CaF₂. The use of a more soluble calcium salt allows better control of the Ca²⁺ concentration in solution to precipitate out large amounts of CaF₂.

As an alternative to precipitating the fluorine using one or more of the aforementioned reactants, a solid phase extractant (SPE) can be used to extract the fluorine from the aqueous solvent comprising fluorine and lithium species. The SPE can be a silica-based adsorbent, a metal-based adsorbent, and/or an ion exchange resin that can adsorb/react with F. Ion exchange resins include, for example, zirconium or aluminium pre-loaded chelating resins with amino-methyl phosphonic acid functionality, a strongly basic anion exchange resin containing quaternary ammonium functional groups, an iminodiacetic acid functionalized cation exchange resin pre-loaded with metal ions (such as Fe³⁺, Al³⁺, Ce³⁺, and/or La³⁺), or a cryptand ligand. Preferably the SPE is a silica-based adsorbent, for example a glass material such as a barium-silicate glass material which can be provided in glass powder form. The fluorine containing wash solution can be passed through a packed column or bed of such an adsorbent to remove fluorine. The adsorbent can periodically be replaced and/or treated to remove the fluorine and re-generate the adsorbent for re-use.

The heat treatment under a reducing atmosphere is intended to break down the waste battery cathode material liberating lithium. In principle, Li₂O is liberated from a lithium nickel manganese cobalt oxide (NMC) cathode material as the NMC material is reduced (collapsing the NMC structure). Depending on the water partial pressure during the heat treatment, Li₂O can hydrolyse to LiOH during the thermal process. XRD analysis of the reduced heat-treated material has shown examples with Li₂O or LiOH. Whether the lithium is present as Li₂O or LiOH, during washing in an aqueous solvent these lithium species are hydrolysed and extracted as LiOH into solution. In addition, the reduced, heat-treated waste battery cathode material comprises LiF and can also include some Li₂CO₃, both of which are also dissolved into the aqueous solvent during washing. As such, after washing the heat-treated waste battery cathode material in the aqueous solvent, the aqueous solvent comprises LiF and one or both of LiOH and Li₂CO₃ (and potentially small quantities of other lithium species such as lithium phosphate). However, it should be noted that LiF is less soluble than LiOH and Li₂CO₃. As such, while a first wash cycle can extract substantially all the Li₂O (as LiOH), LiOH and Li₂CO₃, in order to ensure that substantially all the LiF is also extracted, it can be advantageous to subject the heat-treated waste battery cathode material to one or more further washes in an aqueous solvent, said aqueous solvent generated by said one or more further washes comprising at least LiF, although these one or more subsequent washes may also liberate small quantities of LiOH and Li₂CO₃ if residual amounts are left in the solid material after the first wash cycle.

While a primary purpose of the heat treatment is to break down the waste battery cathode material to convert the lithium into forms which can be washed out of the material with an aqueous solvent, the heat treatment can also volatilize and remove a proportion of the fluorine containing species which would otherwise be washed out in the subsequent aqueous lithium leaching process. This can reduce the amount of fluorine species which wash out in the subsequent aqueous lithium leaching process and thereby reduce the number of wash cycles that are required to remove soluble fluorine species from the solid, heat-treated waste battery cathode material. However, if the heat treatment is performed at a temperature which is sufficiently high to break down insoluble fluorine components (e.g., polyvinylidene difluoride—PVDF) into soluble fluorine species, this can have the opposite effect of increasing the amount of soluble fluorine species in the waste battery cathode material, thus requiring more washing to extract all the soluble fluorine which would otherwise lead to HF formation during an inorganic acid leach. As such, a balance may be struck in terms of heating the material to a sufficient temperature to liberate lithium into soluble forms while being not so high a temperature that insoluble fluorine components are broken down liberating fluorine in soluble forms. For example, the waste battery cathode material may be heated in the reducing atmosphere at a temperature: of at least 200° C., 250° C., 300° C., 350° C. or 400° C.; no more than 600° C., 550° C., 500° C., 450° C., 400° C., 350° C., 300° C., or 250° C.; or in a range defined by any combination of the aforementioned lower and upper values. The heating may be performed for a time period of: at least 5 minutes, 10 minutes, 20 minutes, or 30 minutes; no more than 3 hours, 2 hours, or 1 hour; or within a range defined by any combination of the aforementioned lower and upper limits. The reducing atmosphere can be hydrogen or hydrogen in an inert gas, optionally nitrogen.

It has also been found that a small proportion of lithium may be lost during the thermal treatment. While the calculated Li losses are within experimental error, it is possible that a small Li loss may be due, at least in part, to reaction with the container in which the material is disposed during the thermal treatment. As such, advantageously the thermal treatment is performed in a container which is formed of, or lined with, one or more of: nickel; a nickel alloy; graphite; silicon carbide; a highly densified alumina ceramic; or a mullite porcelain. This aids in reducing lithium losses during the thermal treatment.

In addition to the reductive thermal treatment as described above, optionally the method further comprises heating the waste battery cathode material in an oxidizing atmosphere before or after heating the waste battery cathode material in the reducing atmosphere. This oxidizing heat treatment can be used to remove volatile organics. However, as with the reductive thermal treatment, care must be taken not to decompose insoluble fluorine containing species such as PVDF into soluble fluorine species which require more washing to remove prior to the inorganic acid leaching of the material. As such, heating the waste battery cathode material in the oxidizing atmosphere may be at a temperature less than 400° C., e.g., 250° C. to 350° C. The oxidizing atmosphere may comprise H₂O and/or NH₄OH in an oxidising gas (e.g., air). Such additives can, for example, impact the amount of organo-fluorine compounds that are formed during the oxidative thermal treatment. That said, it should also be noted that the reductive thermal treatment may be effective in removing volatile organics and in certain applications the oxidative thermal treatment may not be required.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows an example of a battery materials recycling process;

FIG. 2 shows another example of a battery materials recycling process;

FIG. 3 shows a flow diagram of a method according to the present specification;

FIG. 4 shows another flow diagram of a method according to the present specification noting that the initial calcination step (oxidative thermal treatment) is optional;

FIG. 5 illustrates an example of parameters used for trialling a reductive thermal treatment followed by a wash with water to extract lithium and fluorine species;

FIG. 6 shows an example of lithium deportments following the process of FIG. 5;

FIG. 7 shows another example of lithium deportments following the process of FIG. 5;

FIG. 8 shows an example of fluorine deportments following the process of FIG. 5;

FIG. 9 illustrates an example of parameters used for trialling an oxidative thermal treatment (calcination) followed by a wash with water to extract fluorine species;

FIG. 10 shows examples of fluorine deportments following the process of FIG. 9 for three different oxidising atmospheres: (a) dry air; (b) H₂O in air; and (c) NH₄OH in air; and

FIG. 11 shows an example of a flow sheet which combines the calcination and reduction treatments.

### DETAILED DESCRIPTION

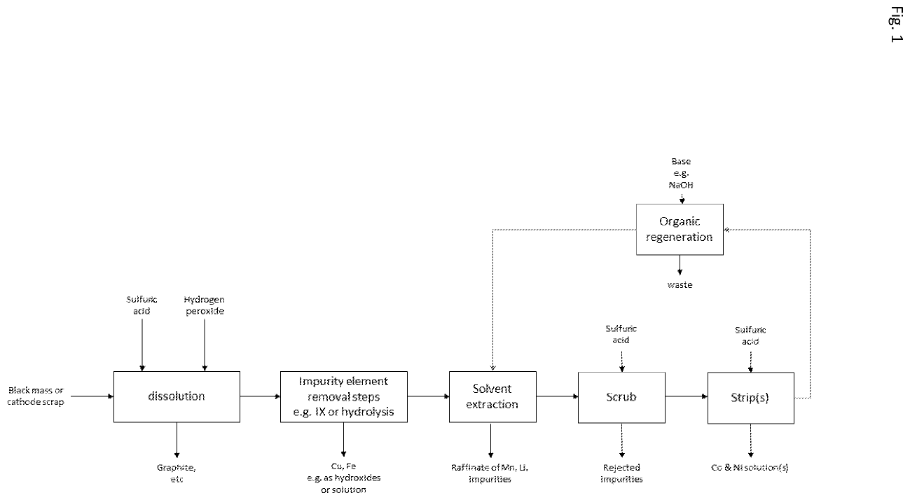

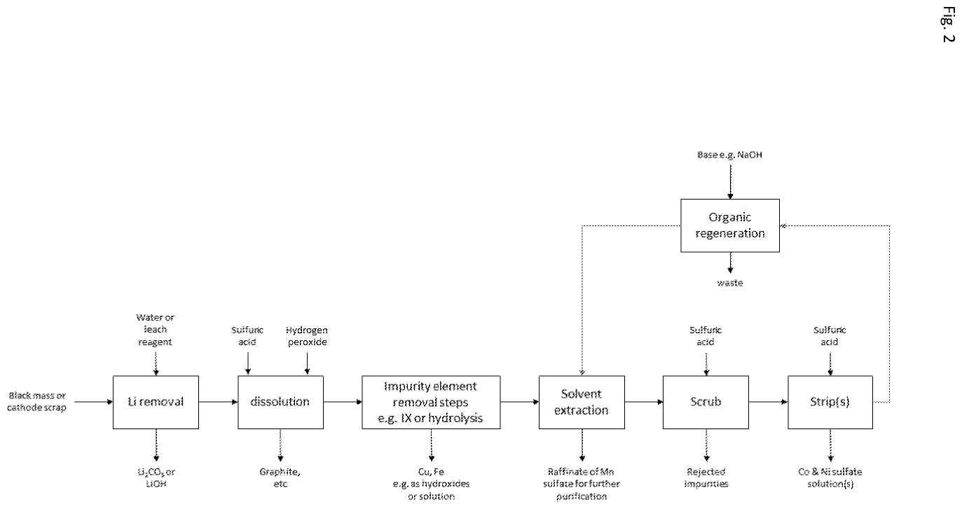

FIG. 1 shows an example of a battery materials recycling process. The starting material is cathode scrap or so-called “black-mass” which typically comprises Li, Ni, Co, Mn and impurities including Cu and Fe. The material is subjected to an acid dissolution or leaching step to obtain an acidic aqueous recycling feed comprising the constituent metal species in solution. The acidic aqueous recycling feed also comprises impurities such as Fe which can interfere with subsequent extraction steps. As such, it is desirable to selectively remove such impurities prior to further processing of the acidic aqueous recycling feed. An organic solvent extraction step can then be applied to separate Co and Ni (in the organic phase) from Mn and Li. An acid scrub can further be applied to the organic phase to remove any remaining impurities prior to stripping of the Co and Ni into aqueous Co and Ni solutions. The organic phase can be regenerated and recycled for use in further extraction of Co and Ni. The method of FIG. 1 enables Co and Ni to be separated from the cathode black mass material. However, further process steps are required if separation of Li and Mn from each other is to be achieved.

FIG. 2 shows another example of a battery materials recycling process. Again, the starting material is cathode scrap or so-called “black-mass” which typically comprises Li, Ni, Co, Mn and impurities including Cu and Fe (Al typically being the third main impurity). However, in this example, the lithium is removed first by treatment with a suitable solvent (e.g. an organic acid such as formic acid) which dissolves Li but not the other metal species. The remaining material is subjected to an acid dissolution or leaching step to obtain an acidic aqueous recycling feed comprising the remaining constituent metal species in solution. Again, the acidic aqueous recycling feed also comprises impurities such as Fe which can interfere with subsequent extraction steps. As such, it is desirable to selectively remove such impurities prior to further processing of the acidic aqueous recycling feed. An organic solvent extraction step can then be applied to separate Co and Ni (in the organic phase) from Mn. An acid scrub can further be applied to the organic phase to remove any remaining impurities prior to stripping of the Co and Ni into aqueous Co and Ni solutions. The organic phase can be regenerated and recycled for use in further extraction of Co and Ni. The method of FIG. 2 is advantageous in that it enables an efficient 4-way separation of Li, Mn, Co, and Ni to be achieved.

For either of the battery materials recycling processes described with reference to FIGS. 1 and 2, a problem arises due to the presence of fluorine containing species in the starting black mass material generating HF during materials processing. Since HF is a serious environmental health and safety risks, it is desirable to remove the fluorine species from the black mass material prior to implementing processing steps to recover valuable metal elements from the material.

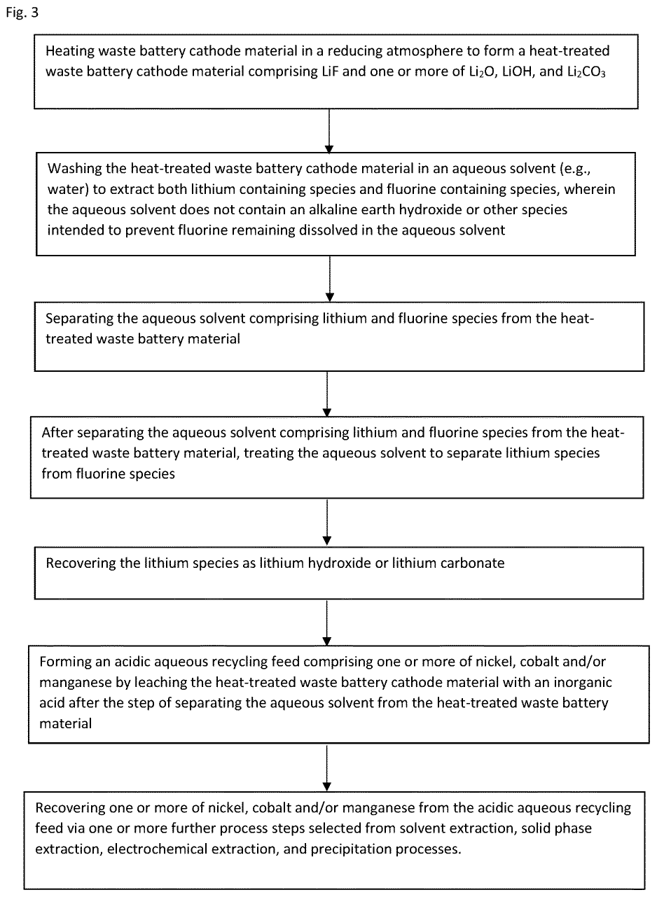

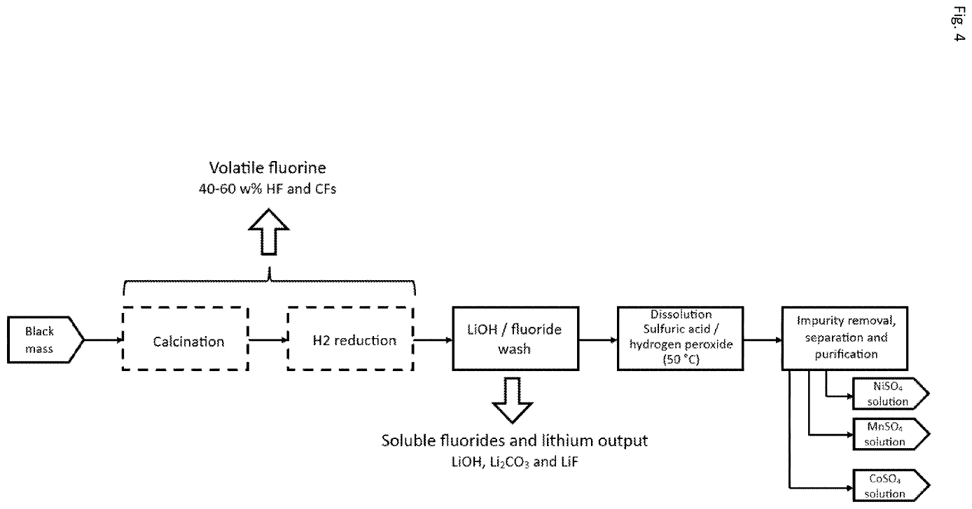

The present specification is directed towards a method of battery materials recycling as shown in FIG. 2 in which the lithium is extracted from the waste battery cathode material prior to a sulfuric acid dissolving step. As described in the summary section, and illustrated in the flow diagram of FIG. 3, the present specification provides a method of recycling a waste battery cathode material comprising lithium and at least one of nickel, cobalt and/or manganese, the method comprising: heating the waste battery cathode material in a reducing atmosphere to form a heat-treated waste battery cathode material comprising LiF and one or more of Li₂O, LiOH, and Li₂CO₃; washing the heat-treated waste battery cathode material in an aqueous solvent (e.g., water) to extract both lithium containing species and fluorine containing species, wherein the aqueous solvent does not contain an alkaline earth hydroxide or other species intended to prevent fluorine remaining dissolved in the aqueous solvent; separating the aqueous solvent comprising lithium and fluorine species from the heat-treated waste battery material; after separating the aqueous solvent comprising lithium and fluorine species from the heat-treated waste battery material, treating the aqueous solvent to separate lithium species from fluorine species; recovering the lithium species as lithium hydroxide or lithium carbonate; forming an acidic aqueous recycling feed comprising one or more of nickel, cobalt and/or manganese by leaching the heat-treated waste battery cathode material with an inorganic acid after the step of separating the aqueous solvent from the heat-treated waste battery material; and recovering one or more of nickel, cobalt and/or manganese from the acidic aqueous recycling feed via one or more further process steps selected from solvent extraction, solid phase extraction, electrochemical extraction, and precipitation processes.

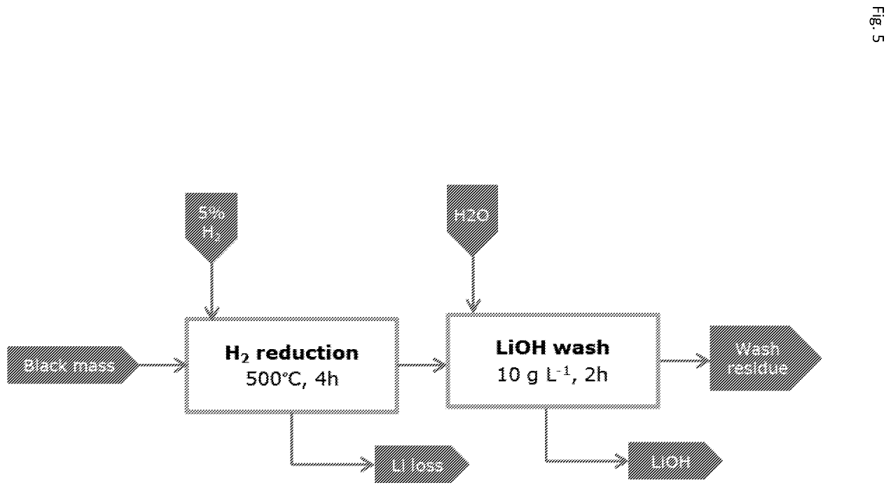

FIG. 4 shows another flow diagram of a method according to the present specification. Optionally, the black mass is first calcined, i.e., subjected to heating in an oxidizing atmosphere. This oxidizing heat treatment can be used to remove volatile organics including volatile fluorine containing species (e.g., HF and volatile organofluorine compounds). For example, the oxidising heat treatment can be used to remove volatile organic solvents (e.g., from electrolyte solution), fluorinated electrolytes that are present as additives, and fluorinated degradation products present in end-of-life cells. Care may be taken not to decompose insoluble fluorine containing species such as PVDF into soluble fluorine species which require more washing to remove prior to an inorganic acid leaching of the material. As such, heating the waste battery cathode material in the oxidizing atmosphere may be at a temperature less than 400° C., e.g., 250° C. to 350° C. The oxidizing atmosphere may comprise additives such as H₂O and/or NH₄OH in an oxidising gas (e.g., air). Such additives can, for example, impact the amount of organo-fluorine compounds that are formed during the oxidative thermal treatment. Such additives can also impact on PVDF decomposition although this is not a significant issue if the temperature is kept below 350° C.

Next, the black mass is subjected to heating in a reducing atmosphere (e.g., hydrogen or a mixture of hydrogen and an inert gas such as nitrogen). This heat treatment breaks down the waste battery cathode material to convert the lithium into forms which can be washed out of the material with an aqueous solvent. The heat treatment also volatilizes and removes a proportion of the fluorine containing species which would otherwise be washed out in the subsequent aqueous lithium leaching process (e.g. LiFP6 decomposition products or volatile fluorinated electrolyte solvents such as fluoroethylene carbonate FEC). This can reduce the amount of fluorine species which wash out in the subsequent aqueous lithium leaching process and thereby reduce the number of wash cycles that are required to remove soluble fluorine species from the solid, heat-treated waste battery cathode material. However, as for the calcining step, if the heat treatment is performed at a temperature which is sufficiently high to break down insoluble fluorine components (e.g., PVDF) into soluble fluorine species, this can have the opposite effect of increasing the amount of soluble fluorine species in the waste battery cathode material, thus requiring more washing to extract all the soluble fluorine which would otherwise lead to HF formation during an inorganic acid leach. As such, a balance may be struck in terms of heating the material to a sufficient temperature to liberate lithium into soluble forms while being not so high a temperature that insoluble fluorine components are broken down liberating fluorine in soluble forms. For example, the waste battery cathode material may be heated in the reducing atmosphere at a temperature: of at least 200° C., 250° C., 300° C., 350° C. or 400° C.; no more than 600° C., 550° C., 500° C., 450° C., 400° C., 350° C., 300° C., or 250° C.; or in a range defined by any combination of the aforementioned lower and upper values. The heating may be performed for a time period of: at least 5 minutes, 10 minutes, 20 minutes, or 30 minutes; no more than 3 hours, 2 hours, or 1 hour; or within a range defined by any combination of the aforementioned lower and upper limits. The reducing atmosphere may comprise a volume percentage of hydrogen of: at least 2%, 3%, 4%, or 5%; no more than 100%, 50%, 30%, 20%, or 10%; or within a range defined by any combination of the aforementioned lower and upper limits. The reducing atmosphere may comprise nitrogen as an inert gas in which the hydrogen is disposed. As such, the reducing atmosphere may comprise or consist essentially of hydrogen or a mixture of nitrogen and hydrogen.

It has also been found that a small proportion of lithium is lost during the thermal treatment. It is believed that this is due, at least in part, to reaction with the container in which the material is disposed during the thermal treatment. As such, advantageously the thermal treatment (the reductive thermal treatment and optionally also the oxidative calcination) is performed in a container which is formed of, or lined with, one or more of: nickel; a nickel alloy; graphite; silicon carbide; a densified alumina ceramic; or a mullite porcelain. This can aid in reducing lithium losses during the thermal treatment.

Next, the black mass is subjected to an aqueous wash to extract both lithium and remaining soluble fluorine species from the solid material while leaving Ni, Co, and Mn species within the solid black mass. The aim here is to extract lithium and soluble fluorine species prior to a subsequent acid dissolve step. Soluble fluorides and lithium are extracted into an aqueous leachate including LiOH, Li₂CO₃, and LiF. LiF is less soluble than Li₂O (hydrolysed to LiOH during washing), LiOH and Li₂CO₃. As such, while a first wash cycle can extract substantially all the Li₂O, LiOH and Li₂CO₃, in order to ensure that substantially all the LiF is also extracted, it can be advantageous to subject the heat-treated waste battery cathode material to one or more further washes in an aqueous solvent, said aqueous solvent generated by said one or more further washes comprising at least LiF, although these one or more subsequent washes may also liberate small quantities of LiOH and Li₂CO₃ if residual amounts are left in the solid material after the first wash cycle.

The remaining solid black mass can then be subjected to an inorganic acid dissolve in sulfuric acid (optionally with hydrogen peroxide) to extract Ni, Co, and Mn species into an acid recycling feed. This is then subjected to impurity removal processes and separation and purification of Ni, Co, and Mn using known methods. A key feature is that the acidic recycling feed is substantially free of HF or HF forming fluorine species which would otherwise cause a health and safety hazard and damage to processing equipment. The present process, which removes soluble HF forming species during preliminary Li removal, enables the solid waste material to be subjected to an acid dissolve without requiring further process steps. For example, after heating the solid waste material and washing as described herein to extract Li and F, the Ni, Co and/or Mn can be leached into the acidic aqueous recycling feed without requiring the solid waste material to be subjected to further processing/separation steps after the Li extraction and prior to the acid dissolve.

The soluble fluorides and lithium extracted in the preceding aqueous wash can be further processed to separate the Li and F species and recover the Li. For example, LiF can be converted to soluble LiOH and insoluble CaF₂ by addition of Ca(OH)₂. The CaF₂ can then be removed by solid-liquid separation prior to recovery of the Li as LiOH via crystallization or recovered as Li₂CO₃ by addition of CO₂. Alternatively, a different alkaline earth hydroxide can be utilized to separate fluorine species from lithium species.

As an alternative to precipitating the fluorine using an alkaline earth hydroxide, it is also possible to use other reactants to precipitate out fluoride material and thus separate fluorine and lithium species using a solid-liquid separation process. Examples of fluoride precipitation reactants include alkali and alkaline earth metal chlorides, hydroxides, carbonates, bicarbonates, acetates, formates, and mixtures of two or more of these reactants. For example, the combination of CaCl₂ and Ca(OH)₂ or NaOH and CaCl₂ can be used in the fluoride precipitation process. Other examples include calcium chloride, calcium bicarbonate, calcium acetate and calcium formate. In this regard, it has also been noted that calcium hydroxide has a relatively poor solubility and is therefore not optimal for precipitating out large amounts of CaF₂. The use of a more soluble calcium salt allows better control of the Ca²⁺ concentration in solution to precipitate out large amounts of CaF₂.

As an alternative to precipitating the fluorine using one or more of the aforementioned reactants, a solid phase extractant (SPE) can be used to extract the fluorine from the aqueous solvent comprising fluorine and lithium species. The SPE can be a silica-based adsorbent, a metal-based adsorbent, and/or an ion exchange resin that can adsorb/react with F. Ion exchange resins include, for example, zirconium or aluminium pre-loaded chelating resins with amino-methyl phosphonic acid functionality, a strongly basic anion exchange resin containing quaternary ammonium functional groups, an iminodiacetic acid functionalized cation exchange resin pre-loaded with metal ions (such as Fe³⁺, Al³⁺, Ce³⁺, and/or La³⁺), or a cryptand ligand. Preferably the SPE is a silica-based adsorbent, for example a glass material such as a barium-silicate glass material which can be provided in glass powder form. The fluorine containing wash solution can be passed through a packed column or bed of such an adsorbent to remove fluorine. The adsorbent can periodically be replaced and/or treated to remove the fluorine and re-generate the adsorbent for re-use.

Alternatively still, another type of separation process may be employed to extract and purify Li from the wash liquid, e.g., an electrochemical separation using a cation exchange membrane to extract Li⁺ions followed by Li recovery as LiOH or Li₂CO₃.

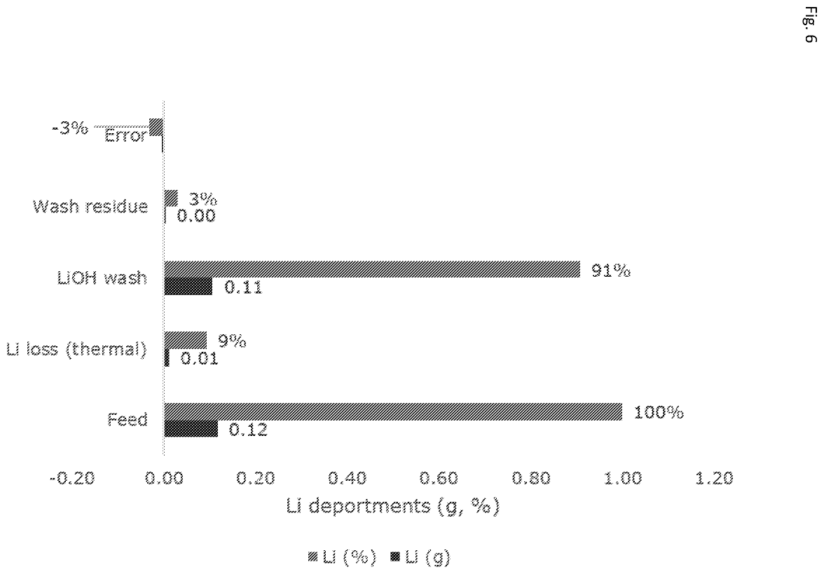

FIG. 5 illustrates an example of parameters used for trialling a reductive thermal treatment followed by a wash with water to extract lithium and fluorine species. Samples of waste battery cathode material were subjected to a thermal treatment at 500° C. for 4 hours under an atmosphere of 5% H₂ in N₂. The heat-treated material was then subjected to a water wash: 10 grams of solid material per litre of water, the solid material being washed for 2 hours. Lithium measurements were performed using inductively coupled plasma spectrometry techniques and lithium mass balance calculations were performed.

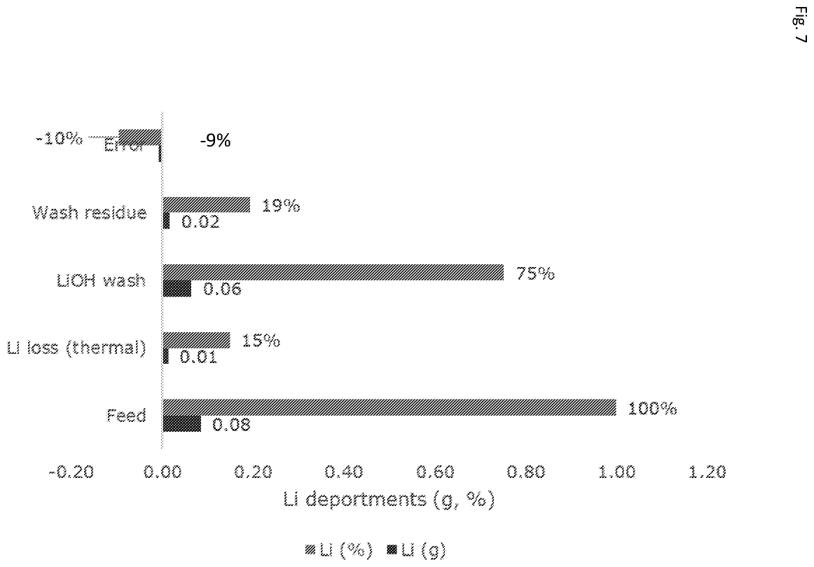

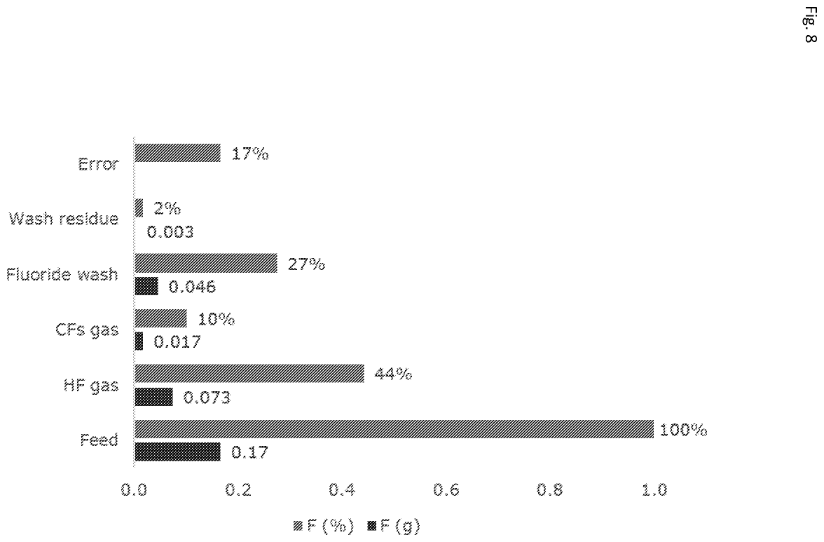

FIG. 6 shows an example of lithium deportments following the process of FIG. 5. In this example, the feed material was a mixture comprising approximately 60 wt % NMC 622 and 40 wt % graphite. Mass balance calculations indicate that 91% of the lithium was recovered in the aqueous wash, 9% of the lithium was lost during the thermal treatment, and 3% of the lithium remained in the solid wash residue. The lithium loss in the thermal treatment may be, at least in part, experimental error. However, there may be a small lithium loss during the thermal treatment due to reaction with the alumina crucible used for the tests and this can be reduced by selecting an alternative crucible, e.g. one which is formed of, or lined with, one or more of: nickel; a nickel alloy; graphite; silicon carbide; a densified alumina ceramic; or a mullite porcelain. The 3% lithium remaining in the solid may also be experimental error, but if there is any lithium remaining in the solid then this could be extracted by further downstream processing of the solid material. It should also be noted that the error of −3% indicated in FIG. 6 implies that the mass balance adds up to 103% when comparing all deportments with the lithium in the feed. Consequently, we are overestimating the individual deportments with a total of 3%.

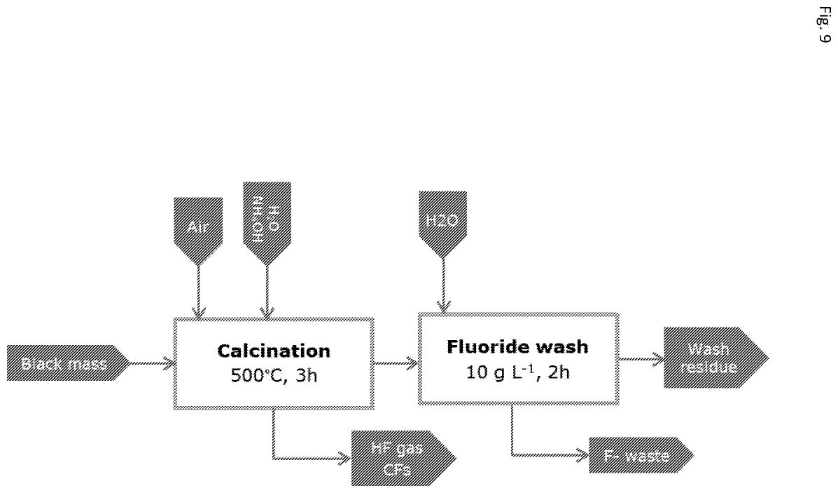

FIG. 7 shows another example of lithium deportments following the process of FIG. 5. In this example, the feed material was a commercial black mass sample. Mass balance calculations indicate that 75% of the lithium was recovered in the aqueous wash, 15% of the lithium was lost during the thermal treatment, and 19% of the lithium remained in the solid wash residue. As in the preceding example, the lithium loss in the thermal treatment may be, at least in part, experimental error. However, there may be a small lithium loss during the thermal treatment due to reaction with the alumina crucible used for the tests and this can be reduced by selecting an alternative crucible, e.g. one which is formed of, or lined with, one or more of: nickel; a nickel alloy; graphite; silicon carbide; a densified alumina ceramic; or a mullite porcelain. The 19% lithium remaining in the solid may also be experimental error, at least in part, but if there is any lithium remaining in the solid then this could be extracted by further downstream processing of the solid material. It should also be noted that the error of −9% indicated in FIG. 7 implies that the mass balance adds up to 109% when comparing all deportments with the lithium in the feed. Consequently, we are overestimating the individual deportments with a total of 9%.

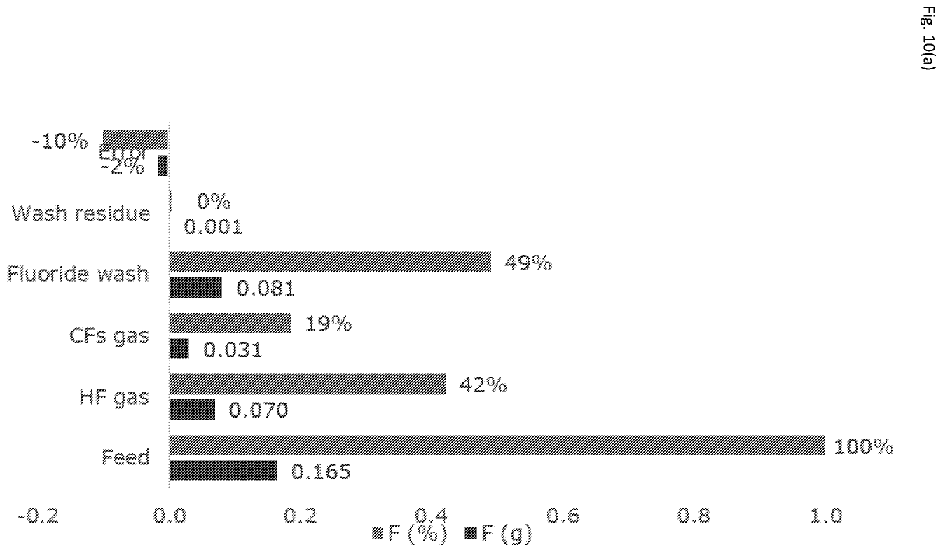

In addition to the lithium measurements/calculations, fluorine mass balance was also calculated based on combustion ion chromatography measurements (IC-AQF). FIG. 8 shows an example of fluorine deportments following the process of FIG. 5 for a feed comprising NMC 622 and PVDF. The figure indicates that approximately 54% of the fluorine was volatilized in the thermal treatment (as volatile organofluorine compounds and HF gas) and approximately 27% of the fluorine was washed out in the aqueous wash. 2% remained in the solid residue although this falls within experimental error. Removal of fluorine from the feed material in this manner means that the solid residue after the aqueous wash is better suited for an inorganic acid dissolve without generating HF.

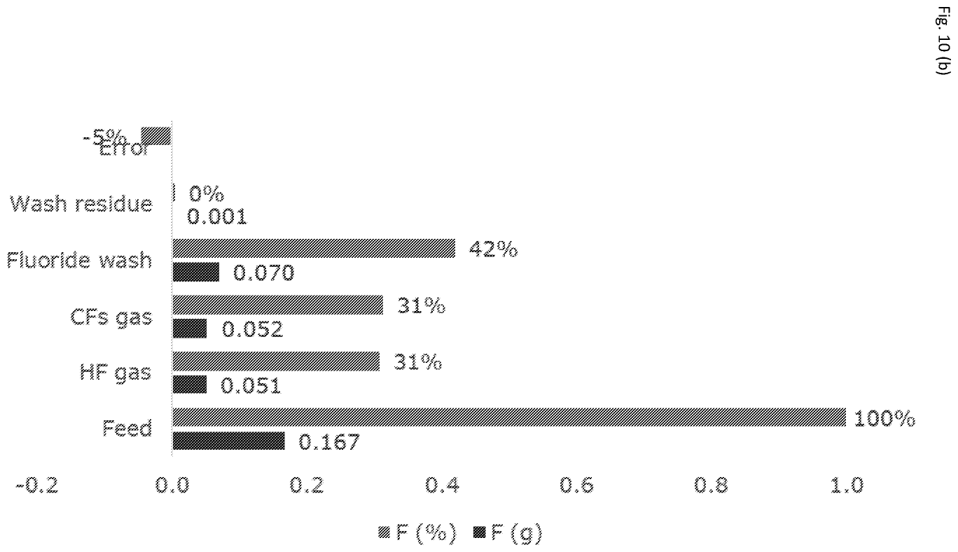

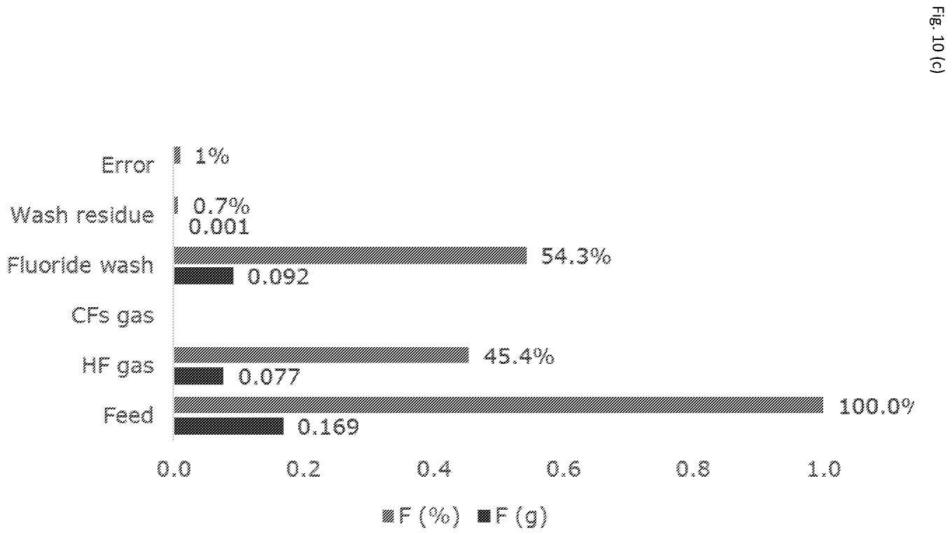

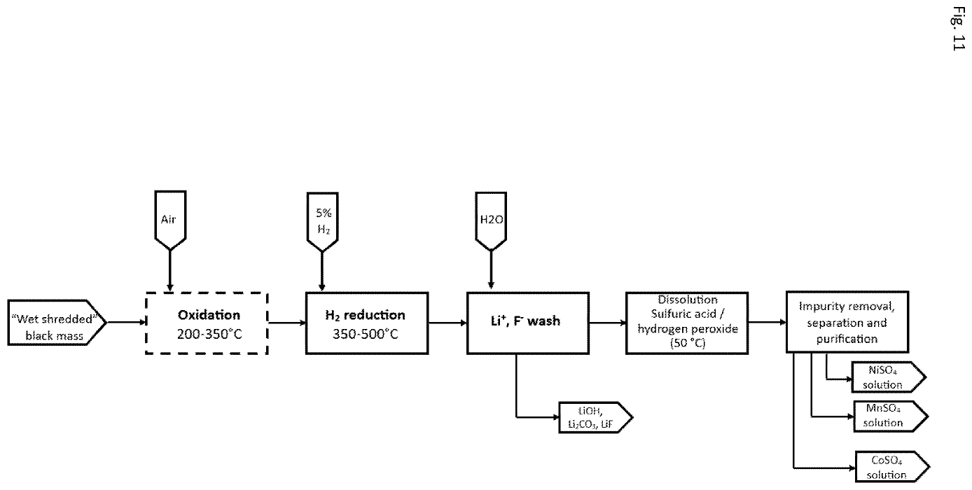

FIG. 9 illustrates an example of parameters used for trialling an oxidative thermal treatment (calcination) followed by a wash with water to extract fluorine species. The feed used in these trials comprised NMC 622 and PVDF. In these experiments, the calcination was performed at 500° C. for 3 hours under three different oxidative atmospheres: dry air; H₂O in air; and NH₄OH in air. The heat-treated material was then washed in water for 2 hours with 10 grams of solid material per litre of water. FIG. 10 shows examples of fluorine deportments following the process of FIG. 9 for the three different oxidising atmospheres: (a) dry air; (b) H₂O in air; and (c) NH₄OH in air. In each case roughly 50% of the fluorine is volatilized during the thermal treatment and roughly 50% of the fluorine is washed out in the aqueous wash. However, the different atmospheres changed the ratio of volatile organofluorine compounds (CFs) and HF gas emitted during the thermal treatment. The experiments indicate that if PVDF decomposes (intentionally or unintentionally) additives such as NH₄OH seem to lower the amount of organo fluorine compounds. While these oxidative trials were performed at 500° C., in practice if the waste battery cathode material contains significant quantities of insoluble fluorine containing material such as PVDF, it can be desirable to remove volatile organics and fluorine species without degrading PVDF into a large quantity of soluble fluorine species prior to washing. As such, one approach is to use a flow sheet which combines calcination and reduction treatments as shown in FIG. 11. In this approach, wet shredded black mass is subjected to an oxidation treatment (e.g., at 200-300° C.) followed by a reduction treatment (e.g., at 200-500° C., optionally less than 300° C.). The heat-treated material is then subjected to an aqueous wash to extract Li and F species prior to an inorganic acid dissolve. Other steps are as previously described for processing the wash fluid to recover Li and processing the acidic recycling feed to recover Co, Ni and Mn.

As previously indicated, for certain applications the oxidative treatment may not be required. Alternatively, the oxidative treatment may be applied after the reductive treatment and wash. That is, the process may comprise the steps: (i) reductive thermal treatment of black mass; (ii) wash/leach of Li/F; (iii) oxidative thermal treatment of black mass; and (iv) acid dissolve of the black mass. The precise optimized parameters for the thermal treatments will vary somewhat according to the variability of the initial waste battery cathode feed material. In general, the source material is advantageously in the form of a powder, e.g., a powder which has a maximum participle size of less than 1 mm. Such a powdered material can be formed by milling the source material prior to applying the thermal treatment. Fluorine and lithium are more readily extracted from such a small particle size source material when compared with a source material which comprises larger pieces/chunks of solid material where fluorine and/or lithium species can be trapped in the interior of the material. The source material may be a battery waste material such as a black mass battery waste material derived from a battery cathode material comprising lithium and at least one of nickel, cobalt and/or manganese. In this case, the black mass may be milled to a small particle size prior to thermal treatment.

As used herein, the term “comprising” means “including”. Variations of the word “comprising”, such as “comprise” and “comprises”, have correspondingly varied meanings. As used herein, the terms “including” and “comprising” are non-exclusive. As used herein, the terms “including” and “comprising”do not imply that the specified integer(s) represent a major part of the whole.

Where applicants have defined an invention or a portion thereof with an open-ended term such as “comprising”, it should be readily understood that (unless otherwise stated) the description should be interpreted to also describe such an invention using the terms “consisting essentially of” or “consisting of”. In other words, with respect to the terms “comprising”, “consisting of”, and “consisting essentially of”, where one of these three terms are used herein, the presently disclosed and claimed subject matter may include the use of either of the other two terms. Thus, in some embodiments not otherwise explicitly recited, any instance of “comprising” may be replaced by “consisting of”or, alternatively, by “consisting essentially of”.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, process or method that includes materials, steps, features, components, or elements, in addition to those literally disclosed, provided that these additional materials, steps, features, components, or elements do not materially affect the basic and novel characteristic(s) of the claimed invention. The term “consisting essentially of”occupies a middle ground between “comprising”and “consisting of”.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be non-restrictive regarding the number of instances (i.e., occurrences) of the element or component. Therefore “a” or “an” should be read to include one or at least one, and the singular word form of the element or component also includes the plural unless the number is obviously meant to be singular.

Other than in the operating examples, or where otherwise indicated, all numbers expressing quantities of ingredients or reaction conditions used herein are to be understood as modified in all instances by the term “about”. The examples are not intended to limit the scope of the invention. Where otherwise indicated herein, “%”or “wt %”will mean “weight %”.

The terms “predominantly” and “substantially” as used herein shall mean comprising more than 50% by weight, unless otherwise defined.

As used herein, with reference to numbers in a range of numerals, the terms “about”, “approximately” and “substantially” are understood to refer to the range of −10% to +10% of the referenced number, preferably −5% to +5% of the referenced number, more preferably −1 % to +1 % of the referenced number, most preferably −0.1 % to +0.1 % of the referenced number, unless otherwise defined. Moreover, with reference to numerical ranges, these terms should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, from 8 to 10, and so forth.

As used herein, wt. % refers to the weight of a particular component relative to total weight of the referenced composition.

The complete disclosures of the patents, patent documents and publications cited herein are incorporated by reference in their entirety as if each were individually incorporated.

Forms of the present invention include:
1. A method of recycling a waste battery cathode material comprising lithium and at least one of nickel, cobalt and/or manganese, the method comprising:
   heating the waste battery cathode material in a reducing atmosphere to form a heat-treated waste battery cathode material comprising LiF and one or more of Li₂O, LiOH, and Li₂CO₃;
   washing the heat-treated waste battery cathode material in an aqueous solvent to extract both lithium containing species and fluorine containing species, wherein the aqueous solvent does not contain an alkaline earth hydroxide or other species intended to reduce or prevent soluble fluorine species remaining dissolved in the aqueous solvent;
   separating the aqueous solvent comprising lithium and fluorine species from the heat-treated waste battery material;
   after separating the aqueous solvent comprising lithium and fluorine species from the heat-treated waste battery material, treating the aqueous solvent to separate lithium species from fluorine species;
   recovering the lithium species as lithium hydroxide or lithium carbonate;
   forming an acidic aqueous recycling feed comprising one or more of nickel, cobalt and/or manganese by leaching the heat-treated waste battery cathode material with an inorganic acid after the step of separating the aqueous solvent from the heat-treated waste battery material; and
   recovering one or more of nickel, cobalt and/or manganese from the acidic aqueous recycling feed via one or more further process steps selected from solvent extraction, solid phase extraction, electrochemical extraction, and precipitation processes.
2. A method according to form 1,
   wherein after washing the heat-treated waste battery cathode material in the aqueous solvent, the aqueous solvent comprises LiF and one or both of LiOH and Li₂CO₃.
3. A method according to form 1 or 2,
   wherein after washing the heat-treated waste battery cathode material in the aqueous solvent, the heat-treated waste battery cathode material is subjected to one or more further washes in an aqueous solvent, said aqueous solvent generated by said one or more further washes comprising at least LiF.
4. A method according to any preceding form,
   wherein the step of treating the aqueous solvent to separate lithium species from fluorine species comprises addition of a precipitation reactant such that fluorine species are precipitated as a fluoride which is then separated from the aqueous solvent by a solid-liquid separation process.
5. A method according to form 4,
   wherein the precipitation reactant is selected from alkali and alkaline earth metal hydroxides, chlorides, hydroxides, carbonates, bicarbonates, acetates, formates, and mixtures of two or more of these reactants.
6. A method according to any one of forms 1 to 3,
   wherein the step of treating the aqueous solvent to separate lithium species from fluorine species comprises adsorbing fluorine onto a solid phase extractant.
7. A method according to form 6,
   wherein the solid phase extractant is one or more of a silica-based adsorbent, a metal-based adsorbent, a solid phase support media functionalized with a basic anion exchange group, and a solid phase support media functionalised with a chelating ligand which is optionally pre-loaded with metal ions.
8. A method according to form 7,
   wherein the adsorbent is a barium-silicate glass material.
9. A method according to any preceding form,
   wherein heating the waste battery cathode material in the reducing atmosphere is at a temperature: of at least 200° C., 250° C., 300° C., 350° C. or 400° C.; no more than 600° C., 550° C., 500° C., 450° C., 400° C., 350° C., 300° C., or 250° C.; or in a range defined by any combination of the aforementioned lower and upper values.
10. A method according to any preceding form,
   wherein the reducing atmosphere is hydrogen or hydrogen in an inert gas, optionally nitrogen.
11. A method according to any preceding form,
   wherein heating the waste battery cathode material in the reducing atmosphere is performed for a time period of: at least 5 minutes, 10 minutes, 20 minutes, or 30 minutes; no more than 3 hours, 2 hours, or 1 hour; or within a range defined by any combination of the aforementioned lower and upper limits.
12. A method according to any preceding form,
   wherein heating the waste battery cathode material in the reducing atmosphere is performed in a container which is formed of, or lined with, one or more of: nickel; a nickel alloy; graphite; silicon carbide; an alumina ceramic; or a mullite porcelain.
13. A method according to any preceding form,
   wherein the method further comprises heating the waste battery cathode material in an oxidizing atmosphere before or after heating the waste battery cathode material in the reducing atmosphere.
14. A method according to form 13,
   wherein heating the waste battery cathode material in the oxidizing atmosphere is at a temperature less than 400° C.

While this invention has been particularly shown and described with reference to certain examples, it will be understood to those skilled in the art that various changes in form and detail may be made without departing from the scope of the invention as defined by the appended claims.

1. A method of recycling a waste battery cathode material comprising lithium and at least one of nickel, cobalt and/or manganese, the method comprising:
heating the waste battery cathode material in a reducing atmosphere to form a heat-treated waste battery cathode material comprising LiF and one or more of Li₂O, LiOH, and Li₂CO₃;
washing the heat-treated waste battery cathode material in an aqueous solvent to extract both lithium containing species and fluorine containing species, wherein the aqueous solvent does not contain an alkaline earth hydroxide or other species intended to reduce or prevent soluble fluorine species remaining dissolved in the aqueous solvent;
separating the aqueous solvent comprising lithium and fluorine species from the heat-treated waste battery material;
after separating the aqueous solvent comprising lithium and fluorine species from the heat-treated waste battery material, treating the aqueous solvent to separate lithium species from fluorine species;
recovering the lithium species as lithium hydroxide or lithium carbonate;
forming an acidic aqueous recycling feed comprising one or more of nickel, cobalt and/or manganese by leaching the heat-treated waste battery cathode material with an inorganic acid after the step of separating the aqueous solvent from the heat-treated waste battery material; and
recovering one or more of nickel, cobalt and/or manganese from the acidic aqueous recycling feed via one or more further process steps selected from solvent extraction, solid phase extraction, electrochemical extraction, and precipitation processes.

2. A method according to claim 1,
wherein after washing the heat-treated waste battery cathode material in the aqueous solvent, the aqueous solvent comprises LiF and one or both of LiOH and Li₂CO₃.

3. A method according to claim 1 or 2,
wherein after washing the heat-treated waste battery cathode material in the aqueous solvent, the heat-treated waste battery cathode material is subjected to one or more further washes in an aqueous solvent, said aqueous solvent generated by said one or more further washes comprising at least LiF.

4. A method according to any one of the preceding claims,
wherein the step of treating the aqueous solvent to separate lithium species from fluorine species comprises addition of a precipitation reactant such that fluorine species are precipitated as a fluoride which is then separated from the aqueous solvent by a solid-liquid separation process.

5. A method according to claim 4,
wherein the precipitation reactant is selected from alkali and alkaline earth metal hydroxides, chlorides, hydroxides, carbonates, bicarbonates, acetates, formates, and mixtures of two or more of these reactants.

6. A method according to any one of claims 1 to 3,
wherein the step of treating the aqueous solvent to separate lithium species from fluorine species comprises adsorbing fluorine onto a solid phase extractant.

7. A method according to claim 6,
wherein the solid phase extractant is one or more of a silica-based adsorbent, a metal-based adsorbent, a solid phase support media functionalized with a basic anion exchange group, and a solid phase support media functionalised with a chelating ligand which is optionally pre-loaded with metal ions.

8. A method according to claim 7,
wherein the adsorbent is a barium-silicate glass material.

9. A method according to any one of the preceding claims,
wherein heating the waste battery cathode material in the reducing atmosphere is at a temperature: of at least 200° C., 250° C., 300° C., 350° C. or 400° C.; no more than 600° C., 550° C., 500° C., 450° C., 400° C., 350° C., 300° C., or 250° C.; or in a range defined by any combination of the aforementioned lower and upper values.

10. A method according to any one of the preceding claims,
wherein the reducing atmosphere is hydrogen or hydrogen in an inert gas, optionally nitrogen.

11. A method according to any one of the preceding claims,
wherein heating the waste battery cathode material in the reducing atmosphere is performed for a time period of: at least 5 minutes, 10 minutes, 20 minutes, or 30 minutes; no more than 3 hours, 2 hours, or 1 hour; or within a range defined by any combination of the aforementioned lower and upper limits.

12. A method according to any one of the preceding claims,
wherein heating the waste battery cathode material in the reducing atmosphere is performed in a container which is formed of, or lined with, one or more of: nickel; a nickel alloy; graphite; silicon carbide; an alumina ceramic; or a mullite porcelain.

13. A method according to any one of the preceding claims,
wherein the method further comprises heating the waste battery cathode material in an oxidizing atmosphere before or after heating the waste battery cathode material in the reducing atmosphere.

14. A method according to claim 13,
wherein heating the waste battery cathode material in the oxidizing atmosphere is at a temperature less than 400°C.
